(19) United States
(12) Patent Application Publication
(10) Pub. No.: US 2004/0002274 A1
(43) Pub. Date: Jan. 1, 2004

(54) Decorative laminate for fibrous insulation products

(76) Inventor: Jeffrey A. Tilton, Prospect, KY (US)

Correspondence Address: OWENS CORNING, 2790 COLUMBUS ROAD, GRANVILLE, OH, 43023, US

(21) Appl. No.: 10/185,220

(22) Filed: Jun. 27, 2002

(51) Int. Cl. B32B 3/00; B32B 5/02; B32B 9/00

(52) U.S. Cl. 442/381; 442/394; 442/340; 442/59

(57) ABSTRACT

A decorative laminate material includes a base layer of fibers selected from a group consisting of polyester, polypropylene, polyethylene, fiberglass, natural fibers, nylon, rayon and blends thereof having a density of between about 0.5 and about 15.0 pcf and a facing layer of polyester fibers having a density of between about 10 pcf and about 100 pcf. The facing layer has an exposed, printed face.

### TECHNICAL FIELD AND INDUSTRIAL APPLICABILITY OF THE INVENTION

The present invention relates generally to the field of insulation products and, more particularly, to a decorative laminate material bearing an exposed, printed face.

### BACKGROUND OF THE INVENTION

Laminate materials of various polymers including but not limited to polyester, polypropylene, polyethylene, nylon and rayon, as well as natural fibers and fiberglass are known to be useful for a number of purposes. Exemplary of the many applications for these materials include office screens and partitions, ceiling tiles, building panels and various vehicle applications including as hood liners, head liners, floor liners and trim panels. Generally, where such laminated materials are going to be highly visible, they are decorated with a fabric facing material. For example, U.S. Pat. No. 4,624,083 to Diffrient discloses an office panel or screen including a three-ply corrugated cardboard sheet septum disposed between two sound insulation pads or panels all covered with decorative fabric.

While such a fabric covering enhances the aesthetic quality of the resulting product, it must be appreciated that it adds significantly to the overall cost of production. Naturally, these added costs must be passed along to the consumer. Further, fabric coverings generally add nothing to the structural as well as the sound and thermal insulating properties of the product.

The present invention relates to an improved decorative laminate material incorporating a facing layer of densified polyester fibers that not only enhances the rigidity and sound attenuating properties of the base acoustical insulating layer but also bears printed patterns, designs, graphics or other indicia on an exposed face thereof so as to display an aesthetically pleasing appearance. Advantageously, this enhanced aesthetic appearance is achieved sans a decorative fabric covering thereby substantially reducing overall production costs.

### SUMMARY OF THE INVENTION

In accordance with the purposes of the present invention as described herein a decorative laminate material is provided. That decorative laminate material includes a base layer of fibers selected from a group consisting of polyester, polypropylene, polyethylene, fiberglass, natural fibers, nylon, rayon and blends thereof having a density of between about 0.5 and about 15.0 pcf and a facing layer of polyester fibers having a density of between about 10 pcf and about 100 pcf. That facing layer also has an exposed, printed face.

The base layer may have a thickness of between about 0.25 and about 3.0 inches while the facing layer may have a thickness of between about 0.01 and about 0.1 inches. Further, the facing layer has an air flow resistance of between about 100,000 and about 3,500,000 mks rayls/meter.

Still further, the polyester fibers of the facing layer have an average fiber diameter of between about 10 and about 50 microns and, more typically, about 10 and about 30 microns.

In accordance with yet another aspect of the present invention, a process is provided for producing a decorative laminate material having a facing layer and a base layer. That process includes the step of providing the facing layer with a density of between about 10 pcf and about 100 pcf.

Additionally, the process includes the steps of printing a selected face of the facing layer and laminating the facing layer and the base layer together. Still further the process may also include the step of rolling the material following laminating.

In accordance with still other aspects of the present invention, a molded product, such as a partition panel and a ceiling tile, constructed from a base layer of fibers and a facing layer of polyester fibers having an exposed, printed face as described are also provided.

In the following description there is shown and described a preferred embodiment of this invention, simply by way of illustration of one of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWING

The accompanying drawing incorporated in and forming a part of this specification, illustrates several aspects of the present invention, and together with the description serves to explain the principles of the invention. In the drawing:

FIG. 1 is a schematical end elevational representation of the decorative laminate material of the present invention which may take the form of a partition panel or a ceiling tile;

FIG. 2 is a schematical top plan view showing the exposed printed face of the facing layer of the decorative laminate material shown in FIG. 1;

FIG. 3 is a chart illustrating the acoustical properties of a decorative laminate material of the present invention including a 1″ thick fibrous blanket base layer; and

FIG. 4 is a chart illustrating the acoustical properties of a decorative laminate material of the present invention incorporating a ½″ thick base layer.

Reference will now be made in detail to the present preferred embodiment of the invention, an example of which is illustrated in the accompanying drawing.

### DETAILED DESCRIPTION OF THE INVENTION

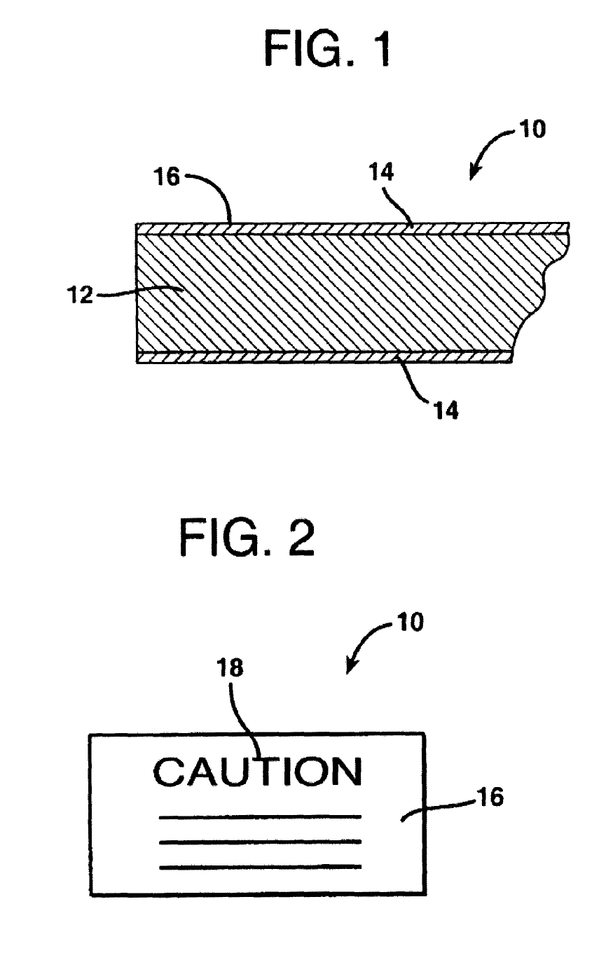

Reference is now made to FIG. 1 showing the decorative laminate material 10 of the present invention. As described and illustrated that decorative laminate material 10 takes the form of a partition panel or ceiling tile. It should be appreciated, however, that these are just two possible applications for the decorative laminate material 10 of the present invention and that they should be considered as being merely illustrative in nature rather than limiting in scope. Exemplary of other possible products are hood liners, head liners, trim panels, vehicle sun visors, building panels, basement finishing systems, bulletin boards, business cards, display boards, picture frames and storage boxes.

As illustrated, the decorative laminate material 10 comprises a base layer 12 of fibers exhibiting desirable acoustical and/or thermal insulating properties as well as moisture wicking. Those fibers may be selected from a group consisting of polyester, polypropylene, polyethylene, fiberglass, natural fibers such as kenaf and cotton, nylon, rayon and blends thereof having a density of between about 0.5 and about 15.0 pcf. In addition, the material 10 includes a facing layer 14 of polyester fibers having a density of between about 10 pcf and about 100 pcf. As illustrated the facing layer 14 includes an exposed face 16 bearing printing 18. Advantageously, the densified face 16 of the facing layer 14 is particularly smooth allowing high definition printing/coloring. The face 16 is also water and stain resistant.

The printing 18 on the exposed face 16 may take substantially any form such as a landscape graphic, a natural wood or stone image, a design, a pattern or indicia. The printing may even take the form of a product warning such as commonly found in automobiles or around other machinery.

The base layer 12 typically has a thickness of between about 0.25 and about 3.0 inches while the facing layer has a thickness of between about 0.01 and about 0.1 inches. Advantageously, the facing layer 14 is significantly densified with respect to the base layer 12 so as to provide additional structural rigidity to the decorative laminate material 10 allowing it to better withstand handling both during installation and use in its operating environment.

Further, the facing layer 14 is constructed from polyester fibers having an average fiber diameter of between about 10 and about 50 microns and, more typically, about 10 and about 30 microns which when densified to a density of between about 10 pcf and about 100 pcf provide an air flow resistance of between about 100,000 and about 3,500,000 mks rayls/meter. Such a facing layer 14 has many advantages over paper and other film facing layers commonly utilized in the art since it retains some degree of air porosity. This provides an acoustical benefit over solid, non-porous films.

In fact, the acoustical properties of the decorative laminate material 10 may be tuned to absorb and/or reflect various frequency ranges by changing the porosity properties of the facing layer 14. Thickness, density and fiber formulation can all be utilized to tune the acoustics to provide better overall sound attenuating properties for any particular application. Papers, fabrics and films generally utilized as decorative facings in office panels, basement finishing systems and ceiling tiles known in the art lack the ability to significantly enhance the acoustics of the finished product. Further, these prior art facings and fabrics are expensive and time consuming to install onto board products thereby significantly increasing production costs.

The decorative laminate material 10 of the present invention is relatively simple and inexpensive to produce. The production process includes providing the facing layer with a density of between about 10 pcf and about 100 pcf. This may be accomplished by any means known in the art to be useful for this purpose including but not limited to hot rolling and pressing operations. This is followed by the printing of a selected face of the facing layer with desired graphics, patterns, designs or indicia.

More specifically, printing may be provided with virtually any color or pattern and in a high level of detail. For example, patterns representing fabric, stone, marble, granite, wood as well as abstract color patterns and fictional or actual photographs may be printed on the exposed face 16 of the facing layer 14. The subject matter capable of being printed on the exposed face 16 is only limited by one's imagination. The printing may be completed by substantially any known printing process suitable for printing on the exposed face 16 of the densified polyester facing layer 14. Exemplary of these techniques, without being limiting, are laser printing, lithography, wallpaper printing processes and heat transfer processes.

The process also includes the laminating of the facing layer 14 to the base layer 12. Where the base layer 12 is constructed from polyester like the facing layer 14, the two layers may be laminated together by applying heat and pressure such as with a hot molding press or heated nip or calendar rolls. Such like materials provide a good bond which resists delamination. An all polyester decorative laminate material 10 also provides other benefits. Specifically, polyester has a tendency to melt back from a flame and when the entire material 10 is constructed from polyester, there is no resistance to this melt back and the product is characterized by superior fire/bum characteristics. Of course, where unlike materials are utilized an appropriate adhesive may be provided between the layers 12, 14 to provide for proper lamination.

The process may also include the rolling of the material 10 following laminating. The material 10 may be shipped in roll or sheet form to an assembly site where it may then be molded into a desired shape. This reduces shipping costs.

The following example is presented to further illustrate the invention, but is not to be considered as limited thereto.

### EXAMPLE

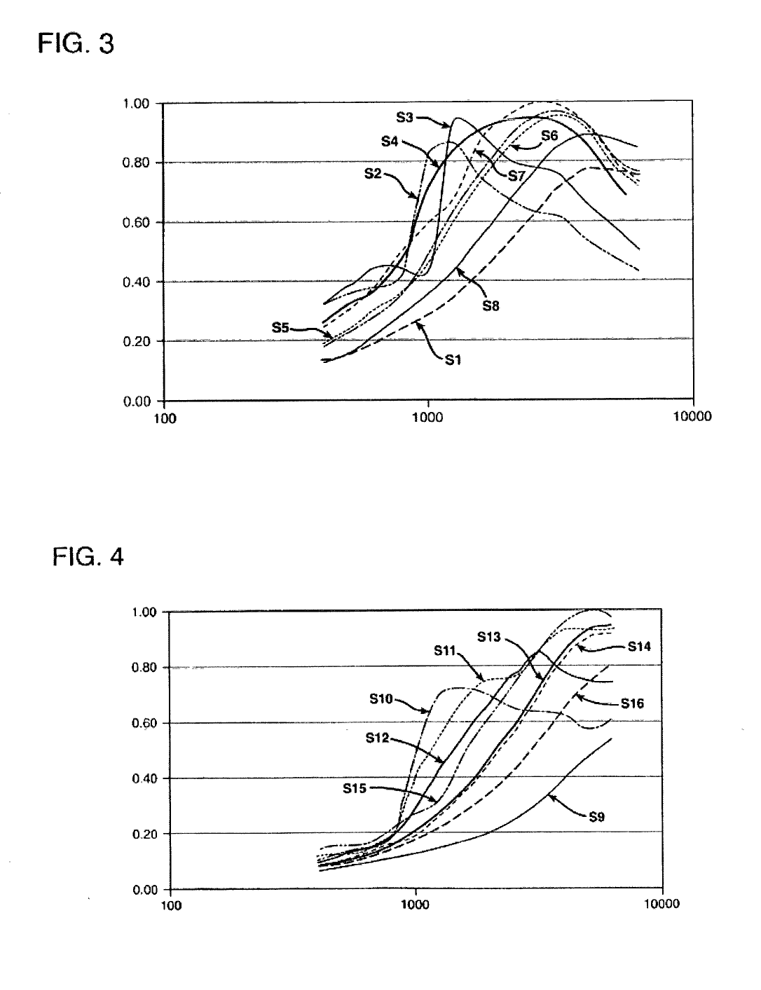

FIGS. 3 and 4 and supporting data show the effect on acoustical properties of a fibrous insulation base layer product when combined with various layers of a thin polymer fiber facing layer. The data was compiled from measuring specimens according to ASTM E1050 procedures utilizing an impedance tube. FIG. 3 represents the results achieved with a 1.0″ thick fibrous blanket base layer and FIG. 4 is for a ½″ thick base layer. It can be clearly seen that the addition of a facing layer (S2-S7, and S10-S15) makes dramatic differences in the acoustical properties of just the base layer (S1, S8, S9, & S16). Depending on how the facing layer is configured, the acoustical properties can be “tuned” to hit desired frequencies.

The following data table describes the configuration of each sample according to total sample thickness tested, how much the base layer of insulation weighed, how thick the facing layer is, how much the facing layer weighed, the calculated air flow resistance of the facing layer, and the total weight of the base layer of insulation plus the weight of the facing layer.

| | | Base | | | | |
|---|---|---|---|---|---|---|
| | Total Sample | Insulation | Facing Layer | Facing Layer | Facing Layer Calculated | Total Sample |
| Sample | Thickness | Weight | Thickness | Weight | Air Flow Resistance | Weight |
| Number | (inches) | (gms/sf) | (inches) | (gms/sf) | (ralys/meter) | (gms/sf) |
| S1 | 1.00 | 0.34 | None | — | — | 0.34 |
| S2 | 1.00 | 0.34 | 0.021 | 0.20 | 1,057,921 | 0.54 |
| S3 | 1.00 | 0.34 | 0.016 | 0.16 | 1,159,585 | 0.50 |
| S4 | 1.00 | 0.34 | 0.027 | 0.17 | 491,023 | 0.51 |
| S5 | 1.00 | 0.34 | 0.042 | 0.14 | 158,037 | 0.48 |
| S6 | 1.00 | 0.34 | 0.089 | 0.16 | 56,058 | 0.50 |
| S7 | 1.00 | 0.34 | 0.099 | 0.27 | 112,031 | 0.61 |
| S8 | 1.00 | 0.49 | None | — | — | 0.49 |
| S9 | 0.50 | 0.17 | None | — | — | 0.17 |
| S10 | 0.50 | 0.17 | 0.021 | 0.20 | 1,057,921 | 0.37 |
| S11 | 0.50 | 0.17 | 0.016 | 0.16 | 1,159,585 | 0.33 |
| S12 | 0.50 | 0.17 | 0.027 | 0.17 | 491,023 | 0.34 |
| S13 | 0.50 | 0.17 | 0.042 | 0.14 | 158,037 | 0.31 |
| S14 | 0.50 | 0.17 | 0.089 | 0.16 | 56,058 | 0.33 |
| S15 | 0.50 | 0.17 | 0.099 | 0.27 | 112,031 | 0.44 |
| S16 | 0.50 | 0.34 | None | — | — | 0.34 |

The following two data tables contain the actual absorption coefficients for samples S1-S16.

| | Sample Number | | | | | | | |
|---|---|---|---|---|---|---|---|---|
| Freq | S1 | S2 | S3 | S4 | S5 | S6 | S7 | S8 |
| 400 | 0.13 | 0.33 | 0.33 | 0.26 | 0.19 | 0.18 | 0.24 | 0.14 |
| 500 | 0.15 | 0.36 | 0.39 | 0.32 | 0.24 | 0.23 | 0.31 | 0.16 |
| 630 | 0.20 | 0.39 | 0.45 | 0.38 | 0.31 | 0.29 | 0.39 | 0.22 |
| 800 | 0.24 | 0.42 | 0.45 | 0.47 | 0.37 | 0.36 | 0.50 | 0.29 |
| 1000 | 0.29 | 0.82 | 0.43 | 0.71 | 0.49 | 0.46 | 0.60 | 0.36 |
| 1250 | 0.35 | 0.87 | 0.94 | 0.84 | 0.64 | 0.60 | 0.68 | 0.44 |
| 1600 | 0.44 | 0.75 | 0.90 | 0.91 | 0.77 | 0.74 | 0.88 | 0.55 |
| 2000 | 0.53 | 0.69 | 0.81 | 0.94 | 0.88 | 0.85 | 0.95 | 0.66 |
| 2500 | 0.62 | 0.63 | 0.79 | 0.95 | 0.95 | 0.93 | 0.99 | 0.77 |
| 3150 | 0.72 | 0.62 | 0.76 | 0.94 | 0.98 | 0.96 | 0.99 | 0.86 |
| 4000 | 0.78 | 0.54 | 0.66 | 0.86 | 0.93 | 0.92 | 0.92 | 0.90 |
| 5000 | 0.78 | 0.48 | 0.58 | 0.74 | 0.82 | 0.82 | 0.79 | 0.88 |
| 6300 | 0.76 | 0.44 | 0.50 | 0.63 | 0.73 | 0.77 | 0.72 | 0.85 |
| freq | S9 | S10 | S11 | S12 | S13 | S14 | S15 | S16 |
| 400 | 0.07 | 0.15 | 0.12 | 0.11 | 0.09 | 0.08 | 0.10 | 0.07 |
| 500 | 0.09 | 0.16 | 0.14 | 0.13 | 0.11 | 0.11 | 0.13 | 0.09 |
| 630 | 0.10 | 0.17 | 0.14 | 0.15 | 0.13 | 0.14 | 0.17 | 0.12 |
| 800 | 0.12 | 0.19 | 0.20 | 0.20 | 0.17 | 0.17 | 0.22 | 0.15 |
| 1000 | 0.13 | 0.49 | 0.40 | 0.31 | 0.22 | 0.20 | 0.28 | 0.18 |
| 1250 | 0.15 | 0.70 | 0.55 | 0.43 | 0.28 | 0.27 | 0.32 | 0.23 |
| 1600 | 0.18 | 0.73 | 0.69 | 0.56 | 0.37 | 0.36 | 0.50 | 0.28 |
| 2000 | 0.21 | 0.70 | 0.75 | 0.67 | 0.47 | 0.45 | 0.62 | 0.35 |
| 2500 | 0.25 | 0.66 | 0.77 | 0.78 | 0.59 | 0.56 | 0.74 | 0.43 |
| 3150 | 0.32 | 0.64 | 0.85 | 0.86 | 0.72 | 0.70 | 0.85 | 0.53 |
| 4000 | 0.39 | 0.63 | 0.79 | 0.94 | 0.86 | 0.83 | 0.95 | 0.65 |
| 5000 | 0.47 | 0.58 | 0.76 | 0.95 | 0.94 | 0.91 | 1.00 | 0.75 |
| 6300 | 0.54 | 0.61 | 0.75 | 0.94 | 0.95 | 0.93 | 0.99 | 0.81 |

The final data table shows how changing the variables that control the properties of the facing layer impact the air flow resistance which in turn impacts the acoustical results. It can be seen from the table that three variables control the air flow resistance, fiber diameter which is a function of the fiber formulation used, the thickness of the facing layer, and the weight of the facing layer. For example, it can be seen that a fiber formulation yielding an average fiber diameter of 10 microns at 0.01″ inches thick and weighing thirteen grams yields the same air flow resistance as a fiber formulation of 30 microns at 0.01″ inches thick and weighing 38 grams. The facing layer weighing 38 grams would generally result in a stiffer layer and since stiffness will also effect the final acoustics the two samples would likely not yield identical curves even though air flow resistance is constant. The net result is that the acoustical properties as well as facing stiffness (which effects structural properties, durability, water resistance, etc) can be infinitely tuned to create a unique solution to a specific set of requirements.

| Fiber | Facing Layer | | Facing Layer Calculated |
|---|---|---|---|
| Diameter | Thickness | Facing Layer | Air Flow Resistance |
| (microns) | (inches) | Weight (gms/sf) | (inks rayls/meter) |
| 10 | 0.01 | 13 | 3,461,209 |
| 20 | 0.01 | 25 | 3,462,788 |
| 30 | 0.01 | 38 | 3,496,920 |
| 10 | 0.02 | 13 | 925,701 |
| 20 | 0.02 | 25 | 925,701 |
| 30 | 0.02 | 38 | 934,960 |
| 10 | 0.02 | 13 | 3,461,209 |
| 20 | 0.02 | 50 | 3,461,209 |
| 30 | 0.02 | 75 | 3,461,209 |
| 10 | 0.03 | 13 | 437,802 |
| 20 | 0.03 | 25 | 437,802 |
| 30 | 0.03 | 38 | 442,064 |
| 10 | 0.04 | 13 | 260,841 |
| 20 | 0.04 | 25 | 260,841 |
| 30 | 0.04 | 38 | 263,320 |

In summary, numerous benefits result from employing the concepts of the present invention. The decorative laminate material 10 of the present invention has enhanced acoustical insulating properties which may be successfully tuned for particular applications. Further, the material has enhanced structural rigidity making it more durable thereby aiding trouble-free installation and enhancing the service life of the final product. The densified facing layer 14 is relatively water-resistant and as such is also stain resistant. The densified facing layer 14 also provides the decorative material 10 with good tackability so that it will not only receive but also hold fasteners and maintain its position following mounting to a wall stud, vehicle body panel or other support.

The foregoing description of the preferred embodiment of the invention has been presented for purposes of illustration and description. It is not intended to be exhaustive or to limit the invention to the precise form disclosed. Obvious modifications or variations are possible in light of the above teachings.

For example, while the decorative laminate material 10 is described and illustrated as incorporating only a base layer 12 and a facing layer 14, it should be appreciated that one or more additional layers of polyester, polypropylene, polyethylene, fiberglass, natural fibers, nylon, rayon and blends thereof as well as even metal foils may be laminated between the base layer 12 and facing layer 14. Still further, a second facing layer 14 may be provided on the opposite side of the base layer 12 so that the base layer 12 is sandwiched between two facing layers 14. In such a construction additional layers of material may also be provided anywhere between the two facing layers.

The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A decorative laminate material, comprising:
a base layer of fibers selected from a group consisting of polyester, polypropylene, polyethylene, fiberglass, natural fibers, nylon, rayon and blends thereof having a density of between about 0.5 and about 15.0 pcf, and
a facing layer of polyester fibers having a density of between about 10 pcf and about 100 pcf, said facing layer having an exposed, printed face.

2. The decorative laminate material of claim 1, wherein said base layer has a thickness of between about 0.25 and about 3.0 inches.

3. The decorative laminate material of claim 2, wherein said facing layer has a thickness of between about 0.01 and about 0.1 inches.

4. The decorative laminate material of claim 3, wherein said facing layer has an air flow resistance of between about 100,000 and about 3,500,000 mks rayls/meter.

5. The decorative laminate material of claim 4, wherein said polyester fibers of said facing layer have an average fiber diameter of between about 10 and about 50 microns.

6. The decorative laminate material of claim 1, wherein said facing layer has a thickness of between about 0.01 and about 0.1 inches.

7. The decorative laminate material of claim 1, wherein said facing layer has an air flow resistance of between about 100,000 and about 3,500,000 mks rayls/meter.

8. The decorative laminate material of claim 1, wherein said polyester fibers of said facing layer have an average fiber diameter of between about 10 and about 50 microns.

9. The decorative laminate material of claim 1, further including a polymer film coating over said exposed face of said facing layer.

10. A process for producing a decorative laminate material having a facing layer and a base layer, comprising:
providing the facing layer with a density of between about 10 pcf and about 100 pcf;
printing a selected face of the facing layer; and
laminating the facing layer and the base layer together.

11. The process of claim 10, further including rolling said material following laminating.

12. A molded product, comprising:
a base layer of fibers selected from a group consisting of polyester, polypropylene, polyethylene, fiberglass, natural fibers, nylon, rayon and blends thereof having a density of between about 0.5 and about 15.0 pcf;
a facing layer of polyester fibers having a density of between about 10 pcf and about 100 pcf, said facing layer having greater rigidity than said base layer; and
printing directly on an exposed face of said facing layer.

13. The molded product of claim 12, wherein said base layer has a thickness of between about 0.25 and about 3.0 inches.

14. The molded product of claim 13, wherein said facing layer has a thickness of between about 0.01 and about 0.1 inches.

15. The molded product of claim 14, wherein said facing layer has an air flow resistance of between about 100,000 and about 3,500,000 mks rayls/meter.

16. The molded product of claim 15, wherein said polyester fibers of said facing layer have an average fiber diameter of between about 10 and about 50 microns.

17. The molded product of claim 12, wherein said facing layer has a thickness of between about 0.01 and about 0.1 inches.

18. The molded product of claim 12, wherein said facing layer has an air flow resistance of between about 100,000 and about 3,500,000 mks rayls/meter.

19. The molded product of claim 12, wherein said polyester fibers of said facing layer have an average fiber diameter of between about 10 and about 50 microns.

20. The molded product of claim 12 comprising a partition panel.

21. The molded product of claim 12 comprising a ceiling tile.
